(19) United States
(12) Patent Application Publication
(10) Pub. No.: US 2007/0133240 A1
(43) Pub. Date: Jun. 14, 2007

(54) Power converter with digital signal processor

(75) Inventors: Karel Leo Manders, Sint Anthonis (NL); Arnold Willem Buij, Eindhoven (NL); Everaard Marie Jozef Aendekerk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,834

(22) PCT Filed: Sep. 9, 2004
(86) PCT No.: PCT/IB04/51719

§ 371 Date: Mar. 21, 2006

(30) Foreign Application Priority Data
Sep. 24, 2003 (EP) 03103528.0

(51) Int. Cl. H02M 7/5383

(52) U.S. Cl. 363/74

(57) ABSTRACT

An up-converter (100) comprises: an inductor (5) and a diode (6) connected in series with an output (3); a capacitor (8) connected in parallel to said output; a controllable switch (7) having one switch terminal coupled to a node between the inductor and the diode. A control method comprises the steps of feeding the inductor with a rectified AC voltage (Vᵢ); and generating a switch control signal (S_{C}) having a pulse width (T_{H}), for switching the switch open and closed; wherein the switch control signal is generated on the basis of the output voltage (Vo) at said output (3). According to the invention, the up-converter comprises a digital processor (110) which samples the output voltage (Vo), and digitally processes the sampled output voltage (Vₒ) to calculate the pulse width (TH) of the switch control signal (S_{C}) such that the output voltage (Vₒ) remains substantially constant.

### FIELD OF THE INVENTION

The present invention relates in general to an up-converter. Particularly, but not exclusively, the present invention relates to an up-converter for use in a lamp driver, e.g. a driver for driving a gas discharge lamp. In the following, the invention will be specifically explained in relation to a driver for driving a gas discharge lamp, but it is to be understood that this is by way of example only and is not intended to restrict the scope of the invention.

### BACKGROUND OF THE INVENTION

A gas discharge lamp should, generally speaking, be supplied with a substantially constant lamp current, whereas the mains can be considered a voltage source supplying alternating voltage. A lamp driver should be designed to receive the alternating voltage from the mains; and use this to generate a substantially constant current, at a voltage determined by the lamp. Further, the driver should be designed such that it does not distort the mains, at least any distortions should remain within predefined margins.

To meet these demands, lamp drivers comprise a first stage or input stage, also indicated as pre-conditioner or up-converter, in which the input alternating voltage received from the mains, typically in the order of 230 VAC, is rectified and converted to a substantially constant output voltage, typically in the order of 400 VDC. The input current drawn from the mains is substantially sinus-shaped.

Prior art up-converters are typically designed around a Power Factor Controller IC (PFC), as illustrated in FIG. 1. Since such prior art design is commonly known to persons skilled in this art, the design and operation of the up-converter will be discussed only briefly.

FIG. 1 schematically shows a prior-art up-converter 1, having input terminals 2 for connection to mains, and having an output terminal 3 for providing a substantially constant output voltage V_{O}. Up-converter 1 comprises a rectifier 4, a converter coil 5 having a first terminal 5a coupled to an output of the rectifier 4, and a diode 6 coupled between a second coil terminal 5b and output terminal 3. An input filter capacitor 4A is coupled in parallel to the output of rectifier 4, and serves to filter out a high-frequency ripple of the output of rectifier 4, i.e. the rectified mains. An output buffer capacitor 8 is coupled in parallel to the output terminal 3, and serves to buffer the voltage at output terminal 3 such as to assure that this voltage is substantially constant. Up-converter 1 further comprises a controllable switch 7, connected between second coil terminal 5b and ground, having a control terminal 7c coupled to a control output 17 of PFC 10. The converter coil 5 is charged with energy from rectifier 4. Output voltage is basically provided by output buffer capacitor 8. In order to maintain the substantially constant output voltage, i.e. the voltage of buffer capacitor 8, PFC 10 controls the opening and closing of the switch 7.

The PFC 10 is designed to operate the converter 1 in the critical mode. To this end, the PFC 10 has a coil sense input 11 coupled to a sense winding 21 of coil 5. To be able to use the peak current through switch 7 as a control parameter, a sense resistor 9 is connected in series with switch 7, and the node between switch 7 and sense resistor 9 is connected to a peak current sense input 19 of the PFC 10. The PFC 10 further has a first input 14 coupled to receive an input measuring signal Si from a first measuring signal generating means 24 adapted to generate the input measuring signal Si on the basis of the filtered rectified mains voltage, indicated in FIG. 1 at Vᵢ. The PFC 10 further has a second output 18 means 28 adapted to generate the output measuring signal So on the basis of the output voltage V_{O} at output 3, in order to be able to calculate a setpoint for the peak current through switch 7.

Such state of the art design has several disadvantages.

The need for a sense winding increases the costs of the converter coil assembly.

The current through switch 7 consists of high frequency current pulses, which means that measuring circuits for measuring the peak switch current must be very fast, even if operating conditions vary only relatively slowly.

In calculating a setpoint for the peak current through switch 7, the PFC 10 needs to multiply the error signal by the mains voltage, in order for the converter to draw a mains current having substantially the same shape as the main voltage. The multiplier, however, only has a limited range. As a consequence, the converter 1 is not capable of handling a large range of input voltages.

In response to variations in input voltage and/or output voltage, the PFC 10 changes the switching frequency of switch 7. This limits the range of input voltages and the range of output powers which the converter 1 can handle. If the converter 1 is to handle universal mains voltage (e.g. in the range of 110 to 280 VAC), and/or if the converter 1 is to handle a variable output power, switching frequencies in the range up to 1 MHz are needed. This leads to high switching losses. Furthermore, this may lead to increased Electromagnetic Interference (EMI).

It is a general objective of the present invention to provide an up-converter in which at least some of the above-mentioned disadvantages are eliminated or at least reduced.

Particularly, the present invention aims to provide an up-converter in which the converter coil assembly does not need a sense winding.

It is a further particular objective of the present invention to provide an up-converter having a large dynamical range of input voltages.

It is a further particular objective of the present invention to provide an up-converter capable of handling a wide range of input voltages and a wide range of output powers.

### SUMMARY OF THE INVENTION

According to a first important aspect of the present invention, an up-converter is operated in discontinuous mode at a constant frequency and variable pulse width.

According to a second important aspect of the present invention, the pulse width is calculated from the input voltage and the output voltage directly. One advantage is that a current sensing resistor in series with the switch, for measuring peak switch current, can be omitted. A further advantage is that the input voltage and the output voltage are signals which vary relatively slowly, so that measuring circuitry does not need to be high-speed circuitry.

According to a third important aspect of the present invention, the converter is controlled by a digital controller, e.g. a digital signal processor. More particularly, the switch is controlled by a digitally generated control signal. One advantage of digitally generating the control signal is that signal processing does not need any further external components. A further advantage is that input signals may easily vary over a relatively wide range.

### BRIEF DESCRIPTION OF THE DRAWINGS

These and other aspects, features and advantages of the present invention will be further explained by the following description of a preferred embodiment of an up-converter according to the present invention with reference to the drawings, in which same reference numerals indicate same or similar parts, and in which:

FIG. 1 is a block diagram schematically illustrating a prior art up-converter;

FIG. 2 is a block diagram schematically illustrating an up-converter according to the present invention;

FIGS. 3A and 3B are block diagrams schematically illustrating lamp drivers.

### DESCRIPTION OF THE INVENTION

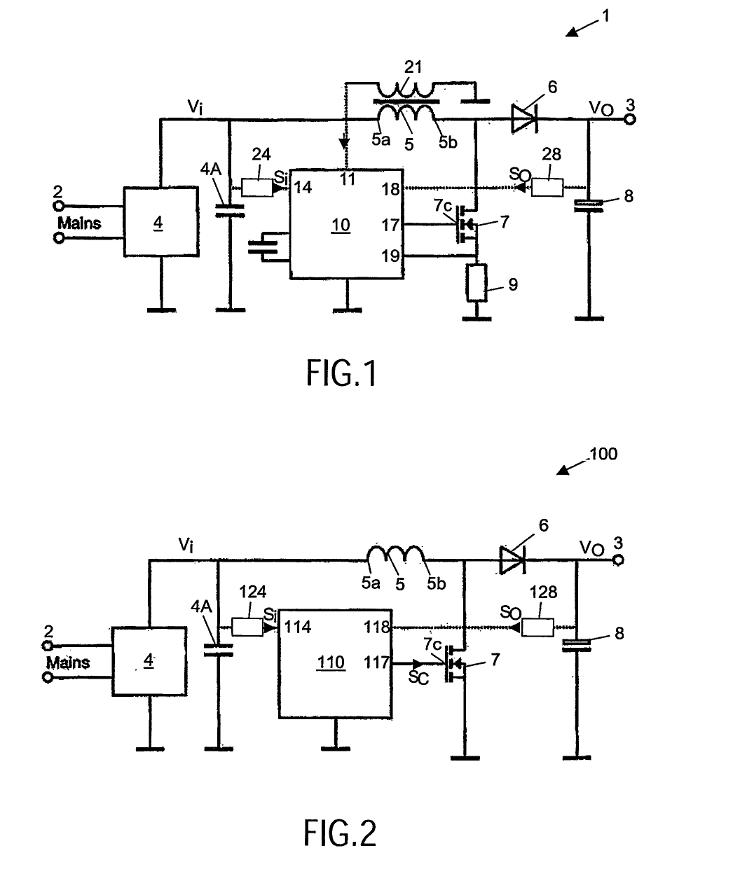

FIG. 2 schematically shows an up-converter 100 in accordance with the present invention. Components having the same reference numeral as components in FIG. 1 have the same or similar function as in prior art, so it is not necessary to repeat the discussion above. It is to be noted, however, that the up-converter 100 in accordance with the present invention does not need to have a coil with a sense winding, nor does it need a sense resistor in series with the switch 7, so these components are absent in FIG. 2.

According to an important aspect of the present invention, the up-converter 100 comprises a digital controller 110. The digital controller 110 may conveniently be implemented as a digital signal processor, or as a programmable array of digital components; or the like, as should be clear to a person skilled in the art. Further, although it is possible that the digital controller 110 is implemented in hardware only, it is preferred that the digital controller 110 is capable of running a software program, so that it can easily be adapted to specific applications.

The digital controller 110 has a first input 114 coupled to a first signal generating means 124 to receive an input measuring signal Si, representative for the filtered rectified mains voltage Vᵢ. The first signal generating means 124 may be adapted to operate digitally, so that the input measuring signal Si is a digital signal, but it is also possible that the digital controller 110 has an analog-to-digital converter (ADC) associated with its first input 114; for sake of simplicity, such ADC is not shown in FIG. 2.

Likewise, the digital controller 110 has a second input 118 coupled to a second signal generating means 128 to receive an output measuring signal So, representative for the output voltage V_{O}. The second signal generating means 128 may be adapted to operate digitally, so that the output measuring signal So is a digital signal, but it is also possible that the digital controller 110 has an ADC associated with its second input 118, which is also not shown for sake of simplicity.

The digital controller 110 is adapted to generate at its control output 117 a control signal Sc for the switch 7, which is a digital control signal having two levels, i.e. a first level for controlling the switch 7 to its non-conductive state and a second level for controlling the switch 7 to its conductive state. For sake of discussion, it will be assumed that the first level is a low level “L” and that the second level is a high level “H”, also indicated as “0” and “1”, respectively. The digital controller 110 is adapted to operate the up-converter 100 in discontinuous mode at a constant frequency and variable pulse width. This means that the control signal Sc is generated at a substantially constant frequency, i.e. the repetition period of successive H-pulses is substantially constant, indicated hereinafter as T. The control signal Sc has a variable pulse width T_{H}, i.e. the duration T_{H} of the H-pulses can be varied. Likewise, the duration T_{L} of the L-pulses is variable, according to
T_{L}=T−T_{H}
The digital controller 110 is adapted to set the pulse width T_{H} such that the resulting output current has a desired characteristic, as will be clear to a person skilled in the art.

### EXAMPLE 1

It can be shown that, in one repetition period T of the control signal Sc, the average current I_{AV} drawn from the mains can be expressed by the following formula (1):

$${I}_{AV} = \frac{{V}_{i} \cdot {T}_{H}^{2}}{2 L \cdot T} \cdot \frac{{V}_{O}}{{V}_{O} - {V}_{i}} \qquad ( 1 )$$

The up-converter is operated in discontinuous mode as long as the condition T_{H}/T<1−Vᵢ/V_{O} is satisfied.

An important function of the up-converter 100 is the function of power factor controller. This means that the up-converter 100 has to assure that the mains current is substantially proportional to the mains voltage. This requirement is expressed in formula (2)
I_{AV}=Vᵢ/R (2)
wherein R is a proportionality constant having the dimension of resistance.

Combining formula (2) with formula (1) shows that said requirement is met if T_{H} is set in accordance with the following formula (3):

$${T}_{H} = \sqrt{\frac{2 L \cdot T}{R}} \cdot \sqrt{\frac{{V}_{O} - {V}_{i}}{{V}_{O}}} \qquad ( 3 )$$

Assuming that V_{O} is constant, it can easily be seen that T_{H} as expressed by formula (3) varies periodically at the mains frequency. L, T and R are constant circuit parameters.

It is noted that T_{H} may be set in accordance with a different formula, if the power factor requirements are different from the requirement of formula (2).

### EXAMPLE 2

The converter of FIG. 2 was tested in an experimental embodiment, where the repetition frequency of the switch control signal S_{C} was set at 50 kHz. The input measuring signal Si and the output measuring signal So were each sampled at a sampling frequency of 6.7 kHz. A digital control loop processed the digitized measuring signals Si and So, and calculated the pulse width in accordance with formula (3); the pulse width was updated every 150 μs. The digital control loop was designed to have a bandwidth of 7 Hz. An alternating voltage power supply was connected to the input 2. The input voltage was varied in a range from 100 to 280 V. A resistive load connected to the output 3 was varied in a range from 16 W to 80 W.

In all cases, operation was found to be stable; the total harmonic distortion was always lower than 14%.

It is noted that rectified mains voltage (at the output of rectifier 4) and the output voltage V_{O} may contain high-frequency signal components, e.g. corresponding to the switching frequency of the switch 7. Preferably, signal components with a frequency higher than the sampling rate of the rectified mains voltage Vᵢ and the output voltage V_{O} are filtered out. Therefore, the digital controller 110 preferably is provided with low-pass filters (not shown) associated with its first and second inputs 114 and 118. These filters may be incorporated in the digital controller 110 itself, or in the corresponding measuring signal generators 124, 128, respectively. By way of non-limiting example, a suitable cut-off frequency for these low-pass filters is in the range of about 1 kHz to about 4 kHz.

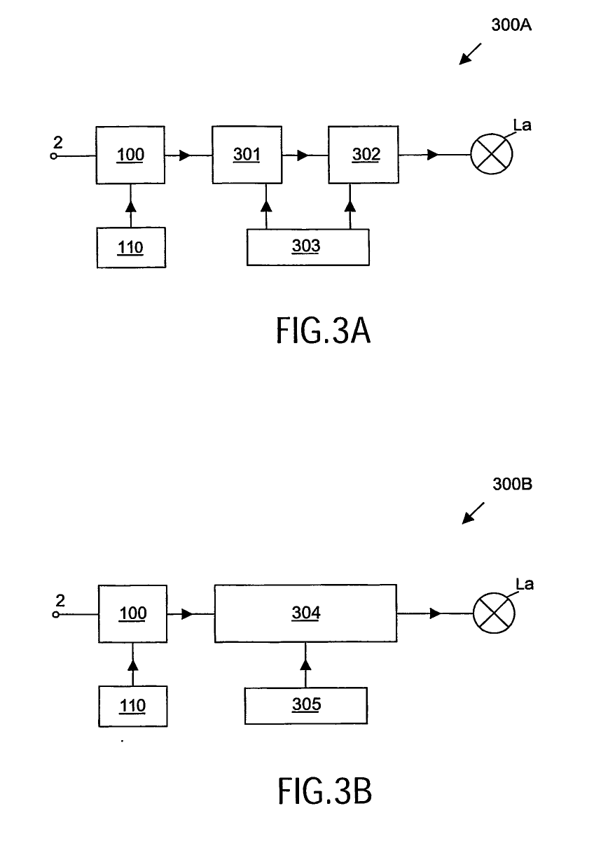

FIG. 3A is a block diagram schematically illustrating a first embodiment of a lamp driver 300A, for driving a gas discharge lamp La. The lamp driver 300A comprises an up-converter 100 as discussed above. A down-converter 301, substantially behaving as a current source for generating a lamp current, receives the constant output voltage of the up-converter 100, and converts this voltage down to a substantially constant second voltage level. A commutator 302 connects the output of down-converter 301 to the lamp La, changing the direction of the lamp current at a predetermined commutation frequency.

In the lamp driver 300A, the operation of the down-converter 301 and the commutator 302, respectively, is controlled by a corresponding controller 303. In FIG. 3A, the controller 303 is shown separate from the digital controller 110 of the up-converter 100. Preferably, however, this controller 303 is a digital controller, integrated with the digital controller 110 of the up-converter 100.

FIG. 3B is a block diagram schematically illustrating a second embodiment of a lamp driver 300B, for driving a gas discharge lamp La. The lamp driver 300B comprises an up-converter 100 as discussed above. A commutating forward bridge 304, for instance implemented as a half-bridge or a full bridge, substantially behaving as a commutating current source for generating a commutating lamp current, receives the constant output voltage of the up-converter 100, and provides commutating lamp current to the lamp La, changing the direction of the lamp current at a predetermined commutation frequency.

In the lamp driver 300B, the operation of the commutating forward bridge 304 is controlled by a corresponding controller 305. In FIG. 3B, the controller 305 is shown separate from the digital controller 110 of the up-converter 100. Preferably, however, this controller 305 is a digital controller, integrated with the digital controller 110 of the up-converter 100.

Thus, the present invention succeeds in providing an up-converter 100 which comprises: an inductor 5 and a diode 6 connected in series with an output 3; a capacitor 8 connected in parallel to said output 3; a controllable switch 7 having one switch terminal coupled to a node between the inductor 5 and the diode 6.

A control method for the up-converter 100 comprises the steps of: feeding the inductor 5 with a rectified AC voltage Vᵢ; and generating a switch control signal S_{C} having a pulse width T_{H}, for switching the switch open and closed at a substantially constant repetition frequency; wherein the switch control signal S_{C} is generated on the basis of a first measuring signal So representing the output voltage Vo at said output 3.

According to the invention, the up-converter comprises a digital processor 110 which samples the first measuring signal So, and which digitally processes the sampled first measuring signal So to calculate the pulse width T_{H} of the switch control signal S_{C} such that the output voltage Vo remains substantially constant.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for controlling an up-converter (100) having an input (2) for receiving an alternating input voltage (MANS), the up-converter (100) further having an output (3), the method comprising the steps of:
providing an inductor (5) and a diode (6) connected in series with said output (3);
providing a capacitor (8) connected in parallel to said output (3);
providing a controllable switch (7) having one switch terminal coupled to a node between the inductor (5) and the diode (6);
feeding the inductor (5) with a rectified AC voltage (Vi) derived from said alternating input voltage (MAINS);
generating a switch control signal (S_{C}) having a substantially constant repetition frequency and a varying pulse width (T_{H}), for switching said switch (7) open and closed;
generating a first measuring signal (So) representing the output voltage (Vo) at said output (3);
sampling the first measuring signal (So) at a first predetermined sampling frequency;
digitally processing the sampled first measuring signal (So) to calculate the pulse width (T_{H}) of the switch control signal (S_{C}) such that the output voltage (Vo) remains substantially constant; and
setting the pulse width (T_{H}) in accordance with the calculation result.

2. Method according to claim 1, wherein the said processing of the sampled first measuring signal (So) and the said calculation of the pulse width (T_{H}) is performed by a software program running in a suitably programmed controller (110).

3. Method according to claim 1, wherein the pulse width (T_{H}) is updated at a predetermined updating frequency.

4. Method according to claim 1, further comprising the steps of generating a second measuring signal (Si) representing said rectified AC voltage (Vi);
sampling the second measuring signal (Si) at a second predetermined sampling frequency, which preferably is equal to the first predetermined sampling frequency, the second measuring signal (Si) and the first measuring signal (So) preferably being sampled simultaneously;
wherein the pulse width (T_{H}) of the switch control signal (Sc) is calculated in accordance with the following formula:
$${T}_{H} = K \sqrt{\frac{{V}_{O} - {V}_{i}}{{V}_{O}}}$$
wherein K is a multiplication constant depending on device parameters.

5. Method according to claim 1, wherein the first predetermined sampling frequency is substantially equal to the said repetition frequency of the control signal (S_{C}).

6. Method according to claim 1, wherein the up-converter (100) is part of a driver (300A; 300B) for a gas discharge lamp.

7. Method according to claim 1, wherein the input (2) of the up-converter (100) is connected to mains.

8. Up-converter (110), comprising:
an input (2) for receiving an alternating input voltage (MAINS);
an output (3);
a rectifier (4) having its input connected to said input (2), and having an output providing a rectified AC voltage (Vi);
an inductor (5) and a diode (6) connected in series with the output (3), the inductor having a first terminal (5a) coupled to said output of said rectifier (4) and having a second terminal (5b) coupled to said diode (6);
a capacitor (8) connected in parallel to the output (3);
a switch (7) having one switch terminal coupled to a node between the inductor (5) and the diode (6);
a digital processor (110) having a first input (118) coupled to receive a first measuring signal (So) representing the output voltage (Vo) at said output (3), and further having a control output (117) coupled to a control terminal of said switch (7);
the digital processor (110) being adapted:
to generate at its control output (117) a switch control signal (S_{C}) having a pulse width (T_{H}) and a substantially constant repetition frequency, for switching the switch (7) open and closed;
to sample the first measuring signal (So) at a first predetermined sampling frequency, which preferably is equal to the said repetition frequency;
to digitally process the sampled first measuring signal (So) to calculate the pulse width (T_{H}) of the switch control signal (S_{C}) such that the output voltage (Vo) remains substantially constant;
and to set the pulse width (T_{H}) of the switch control signal (S_{C}) in accordance with the calculation result.

9. Up-converter according to claim 8, wherein the digital processor (110) comprises a software program running to perform at least the step of calculating the pulse width (T_{H}) of the switch control signal (S_{C}).

10. Up-converter according to claim 8, wherein the digital processor (110) further comprises a second input (114) coupled to receive a second measuring signal (Si) representing the said rectified AC voltage (Vi);
the digital processor (110) being adapted to sample the second measuring signal (Si) at a second predetermined sampling frequency, which preferably is equal to the said first sampling frequency, the digital processor (110) preferably being adapted to sample the second measuring signal (Si) simultaneously with the first measuring signal (So);
the digital processor (110) being adapted to calculate the pulse width (T_{H}) of the switch control signal (S_{C}) in accordance with the following formula:
$${T}_{H} = K \sqrt{\frac{{V}_{O} - {V}_{i}}{{V}_{O}}}$$
wherein K is a multiplication constant depending on device parameters.

11. Driver (300A; 300B) for a gas discharge lamp, comprising an up-converter (100) according to claim 8.
